(19) United States
(12) Patent Application Publication
(10) Pub. No.: US 2009/0081112 A1
(43) Pub. Date: Mar. 26, 2009

(54) PROCESS AND APPARATUS FOR PRODUCING SUSPENSIONS OF SOLID MATTER

(75) Inventor: Pentti Virtanen, Valkeakoski (FI)

Correspondence Address: MCCORMICK, PAULDING & HUBER LLP, CITY PLACE II, 185 ASYLUM STREET, HARTFORD, CT, 06103, US

(73) Assignee: NORDKALK OYJ ABP, Pargas (FI)

(21) Appl. No.: 12/094,012

(22) PCT Filed: Nov. 20, 2006
(86) PCT No.: PCT/FI2006/000380

§ 371 Date: Nov. 19, 2008

(30) Foreign Application Priority Data
Nov. 18, 2005 (FI) 20051182

(51) Int. Cl. C01F 11/18; B01J 8/00

(52) U.S. Cl. 423/432; 422/188; 422/187

(57) ABSTRACT

Method for producing nanosized calcium hydroxide crystals or particles, according to which method the calcium oxide-bearing initial material is brought into contact with carbon dioxide in the aqueous phase. Calcium carbonate crystals or particles are produced in a mixture, the pH of which is below 7. Using the present invention, it is possible to combine the two stages of producing CaCO₃ particles into one entity, in which case the overall processing time is shortened and the use of external energy is minimized.

### CROSS REFERENCE TO RELATED APPLICATIONS

This application is entitled to the benefit of and incorporates by reference essential subject matter disclosed in International Patent Application No. PCT/FI2006/000380 filed on Nov. 20, 2006 and Finish Patent Application No. 20051182 filed Nov. 18, 2005.

### TECHNICAL FIELD

The present invention relates to a method for producing suspensions of solid matter, especially suspensions of calcium carbonate.

According to such a method, a calcium oxide-bearing initial material is brought to react in the aqueous phase with a carbonating reagent in order to produce calcium carbonate. If desired, the calcium carbonate can be recovered and dried in order to produce a powdery product.

The present invention also relates to an apparatus for producing suspensions of solid matter.

### BACKGROUND ART

Several processes of producing calcium carbonate, which herein is also referred to as precipitated calcium carbonate (PCC), are already known. In the known solutions, the operation is generally based on the “dose principle” and the production time is 2-8 hours, depending on the temperature. Generally, the process for producing carbonate is divided into three parts, which are described by the following equations:

CaCO₃(<900° C.)→CaO+CO₂ 1.

CaO+H₂O→Ca(OH)₂+cleaning 2.

Ca(OH)₂+CO₂→CaCO₃+H₂O 3.

Generally, the starting point is ready-prepared CaO, which is subsequently processed into CaCO₃. However, it is also possible to start with natural limestone, which is calcined in order to break it down into calcium oxide and carbon dioxide.

The calcium hydroxide generated after the hydration process (reaction 2) is carbonated into calcium carbonate according to reaction 3. The temperature can vary widely. The temperature can affect the particle size distribution and the crystal structure of the product to be produced. Accordingly, in the “cold method”, in which the temperature is lower than approximately 30° C., especially lower than approximately 20° C., CaCO₃ particles are generated, the average particle size of which is in the range of 50-500 nm.

In the fluid method, where both the aqueous dispersion of the initial material and the carbonation agent stream through the carbonation zone, the carbonation is carried out in a device having 1 or 2 rotors, generally in two or three consecutive stages. The initial material is typically Ca(OH)₂, from which impurities have been removed. CaCO₃ particles of size 2-20 nm are generated, which form a firm agglomeration which is held together by van der Waals' forces.

The initial material can be CaO, too, but because of the refining effect of the rotors, the impurities are also refined into a fine fraction within the generated agglomeration.

The following formulas illustrate the fluid method:

CaO+H₂O→Ca(OH)₂ 4.

Ca(OH)₂+CO₂<100%→CaCO₃+H₂O 5.

or

CaO+H₂O+CO₂<100%→CaCO₃+H₂O(CO₂) 6.

Known technologies are described in the solutions in WO Patent Applications 98/41475, 99/12851 and 99/12852.

The most traditional method for producing carbonate is to use a causticizing process, in which the carbonation agent is not gaseous carbon dioxide but a carbonate compound, such as sodium carbonate.

The following reaction equations describe causticizing process:

CaO+H₂O→Ca(OH)₂ and 4.

Ca(OH)₂+Na₂CO₃→CaCO₃(↓)+2NaOH 7.

The problematic part of the process is how to separate the sodium hydroxide from the CaCO₃ particles.

According to a more advanced form of the method, during the reaction described in equation 8, the process is halted in the gel phase and, as a result, approximately 50 nm CaCO₃ particles are generated. In this respect, we refer to WO Patent Application 97/23728.

The causticized product is most suitably washed in a filter, into which CO₂ gas is introduced (see WO Patent Application 97/38940). As a result, according to reaction formula 8, the lye can be transformed into soda:

2NaOH+CO₂→Na₂CO₃+H₂O 8.

and further, the soda into salt according to formula 9:

Na₂CO₃+2HCl→2NaCl+H₂O+CO₂ 9.

washing of salt

The method is advantageous because both basic products, CaCO₃ and NaOH, are useful. However, the investment cost is high because of the filtering apparatus.

It is also possible to produce fine CaCO₃ from other kinds of raw materials than directly from calcium oxide. An example is the Solvay soda process, in which the initial material is calcium chloride (reaction formulas 10 and 11):

CaCl₂+Na₂CO₃→CaCO₃+2NaCl 10.

CaCl₂+2NaOH+CO₂→CaCO₃+2NaCl+H₂O 11.

According to an alternative method, calcium phosphate and nitrous acid, too, are used as the initial materials:

Ca₃(PO₄)₂+2HNO₂2CaHPO₄+Ca(NO₃)₂ 12.

Ca(NO₃)₂+2NaOH+CO₂CaCO₃+2NH₄NO₃+H₂O 13.

The average size of the CaCO₃ particles generated is 20-500 nm.

The earlier methods used for producing small-sized (generally <500 nm) CaCO₃ particles suffered from one or more of the following disadvantages:
large investment/product tonne
the process is slow
to speed up the process requires the addition of mechanical energy
expensive initial materials
dose preparation.

### SUMMARY OF THE INVENTION

The purpose of the present invention is to eliminate at least some of the disadvantages associated with the known technique and to generate a new solution for producing calcium carbonate.

The present invention is based on the idea that the carbonation of the initial calcium oxide material is carried out in a water-containing environment which is slightly acidic. The reason is that we have unexpectedly discovered that by carbonating calcium hydroxide with carbon dioxide or a similar carbonating reagent in slightly acidic conditions, very small and equally-sized calcium carbonate crystals are generated. On the basis of our tests, it seems that by keeping the pH value of the aqueous phase of the carbonation below 7, for instance by forming calcium hydrogen carbonate in the water, the primary crystals of the calcium carbonate which were generated during the carbonation process cannot grow. Instead, the particle size of the calcium carbonate is dependent on how the primary crystals are fused, which, in turn, varies depending on the quantity of crystals and particles in the mixture. This is, however, only one of several possible explanations, and we do not want to commit ourselves to any specific theory.

According to the present invention, when operating in slightly acidic conditions, the particles generated have an average particle size of approximately 1-1000 nm, preferably approximately 1-500 nm, especially approximately 2-200 nm.

To create suitable conditions, it has been found advantageous to recirculate internally a significant part of the solids suspension of the carbonation and to remove from the carbonation process only approximately 30%, preferably even at maximum 10% of the suspension quantity (calculated from the weight).

The apparatus according to the present invention needed to carry out this preferable form of application therefore comprises:
a source of carbon dioxide, and
a unit for the carbonation of calcium hydroxide, which unit is equipped with an input nozzle for introducing the aqueous suspension of hydrated calcium oxide, an input nozzle for introducing the carbon dioxide which is connected to the carbon dioxide source, and an outlet nozzle for leading out the aqueous suspension of calcium carbonate.

In this case, it is characteristic of the apparatus that the outlet nozzle of the carbonation unit, through which nozzle the aqueous suspension of calcium carbonate can be removed from the unit, is connected via a pipeline leading to the input nozzle of carbon dioxide, which is upstream from the carbonation unit, in order to enable the recirculation of at least the main part of the aqueous suspension of calcium carbonate inside the carbonation unit.

More specifically, the method according to the present invention is mainly characterized in that the calcium carbonate crystals or particles are produced in a mixture, the pH of which is below 7, in which case the component which keeps the mixture acidic is calcium hydrogen carbonate, Ca(HCO₃)₂.

The apparatus according to the present invention is, in turn, characterized in that the carbonation unit is equipped with a recirculation pipe which is connected to the outlet nozzle for the calcium carbonate, through which pipe at least part of the product from the reactor can be recirculated in order to keep the pH value of the aqueous suspension at a value which is lower than 7, during the carbonation.

Considerable advantages are obtained by means of the invention: by combining into one entity the two stages of the production of CaCO₃ particles, a short total processing time is achieved and the use of external energy is minimized. In the present invention, the energy bound within the calcium oxide is exploited to produce nanosized Ca(OH)₂ crystals or particles by carrying out the process at a temperature exceeding 100° C. and at a pressure which prevents the water evaporating. Water which comprises large quantities of Ca(HCO₃)₂ is used in the process. During the carbonation process, the pH value is kept slightly acidic, which prevents the formation of large agglomerates. The product of the carbonation can be easily separated as flocculates which, in turn, can be broken down into small particles.

The process according to the present invention is rapid.

### DESCRIPTION OF DRAWINGS

In the following, the present invention will be examined in more detail with the aid of a detailed description and with the help of the accompanying drawings:

FIG. 1 shows a flow diagram of the basic structure of the apparatus which is the solution according to the first embodiment of the present invention.

FIG. 2 shows a flow diagram of the basic structure of the apparatus which is the solution according to the second embodiment of the present invention.

FIG. 3 shows a SEM picture of calcium carbonate particles which are produced according to the present invention.

### DETAILED DESCRIPTION OF PREFERRED EMBODIMENTS

In the invention, particles which have an average particle size of less than approximately 1 micrometre are called “nanoparticles”. Typically, according to the present invention, it is possible to produce particles that have an average particle size of approximately 500 nm at maximum and more than 1 nm. Thus, the preferable range is 2-500 nm, especially approximately 10-500 nm, most suitably approximately 10-250 nm or 10-200 nm. In the present application, the products are also marked “CaCO₃<500 nm”, which here means the same as “nanoparticles”.

“Slightly acidic” conditions refer to a pH range which ranges from approximately 5 to less than 7, preferably approximately 5.5-6.8, especially approximately 5.7-6.5.

As described above, during the first stage of the process the calcium oxide is hydrated with water into calcium hydroxide according to formula 4:

CaO+H₂O→Ca(OH)₂ 4.

According to the invention, in order to keep the water in the liquid phase, the temperature is kept higher than approximately 100° C. and the pressure higher than normal atmospheric pressure during the hydration. Preferably, the process is carried out at a temperature of approximately 105-150° C., preferably approximately 110-140° C., especially approximately 130° C.

The process is carried out at overpressure. The pressure is especially approximately 1.1-10 bar, preferably approximately 1.5-8 bar, more preferably approximately 4 bar absolute pressure.

During hydration, calcium hydroxide particles are generated, the average particle size of which is at maximum approximately 20 nm (especially approximately 1-20 nm). Particles develop in the aqueous suspension, the solids percentage of which is generally approximately 1-20 weight %. The water used in the hydration can comprise Ca(HCO₃)₂ approximately 0-16 g/l, especially approximately 1-4 g/l.

In the second stage of the process, the calcium hydroxide is carbonated with carbon dioxide by blending the Ca(OH)₂—generally in the form of the solids suspension generated in the previous stage—cold water and CO₂. Depending on the use of products, i.e. nanosized particles (“CaCO₃<500 nm”) and calcium hydrogen carbonate Ca(HCO₃)₂, the water is either pure water or recirculated water which comprises Ca(HCO₃)₂. The carbonation is carried out in a system made up of a mixer and pipes, in which a large amount of carbon dioxide is flowing, and the carbonation is continued so that the pH is lower than 7, in practice the pH is kept at a value of 5.5-6.5 during the carbonation.

As described above, precipitated calcium carbonate is produced with the present method. The shorter term “calcium carbonate”, too, is used hereinafter.

Most suitably, the carbonation stage is carried out under pressurized conditions immediately after the hydration of the calcium oxide. In the first part of the carbonation, the temperature of the Ca(OH)₂ mixture is decreased to under 100° C., by bringing cold water into the mixture. CO₂ gas is then bubbled into this cooling water. The pressure of the process lies in the CO₂ bubbles, which pressure accelerates the dissolving of the carbon dioxide into the process water.

In the carbonation, Ca(OH)₂ particles, CO₂ microbubbles and water, which comprises calcium hydrogen carbonate and CO₃²⁻↓ ions, undergo mixing and, as a result, nanoparticles of calcium carbonate are generated.

We have discovered that when the Ca(OH)₂ reacts, this reaction seems to take place on its surface, in which case small crystals form a large surface area. When hydrating CaO at a temperature exceeding 100° C., nanosized Ca(OH)₂ crystals which have a large surface area are generated.

Carbon dioxide gas dissolves into water according to the following general formula:

CO₂+H₂O→H₂CO₃ 14.

Carbonic acid reacts further with calcium carbonate, thereby forming calcium hydrogen carbonate according to reaction 15 below:

H₂CO₃+CaCO₃→Ca(HCO₃)₂ 15.

This, in turn, reacts with calcium hydroxide:

Ca(HCO₃)₂+Ca(OH)₂→2CaCO₃+2H₂O 16.

The slowest of the reactions described is the dissolving of carbonic acid, according to reaction 14, (CO₂+H₂O→H₂CO₃). According to the present invention, this reaction is accelerated by raising the temperature. In this case, the solubility of the carbon dioxide decreases, which is corrected by raising the pressure of the carbon dioxide and, as a result, the amount of carbon dioxide inside the bubbles increases. For instance, the amount of carbon dioxide at a pressure of 4 bar is approximately 1.56-fold compared to the amount of carbon dioxide at a pressure of 1 bar.

The processing time has no effect on the size of the CaCO₃ crystals which are generated in the “acidic method” according to the present invention. Indeed, the processing time impacts only on the size of the apparatus and thus its economic efficiency.

As described above, the pH of the calcium carbonate mixture must be kept lower than 7 (preferably approximately 5.5-6.8), which can be achieved by preventing the decomposition of the calcium hydrogen carbonate, according to reaction formula 17 below, in such a way that the CO₂ produced by decomposition is not allowed to exit:

Ca(HCO₃)₂→2CaCO₃+CO₂+H₂O

The carbon oxide can be kept in the liquid phase by using a closed reaction vessel, overpressure, and by recirculating the suspension which comprises the reaction product. The volume of suspension recirculated is approximately 5 to 50-fold the volume to be taken out.

Overpressure, preferably 1.1-11 bar, especially 1.5-11 bar absolute pressure, is used both in the processing and in the hydration of the calcium oxide.

The reactions

Ca(OH)₂+CO₂CaCO₃+H₂O

CaCO₃+CO₂+H₂O→Ca(HCO₃)₂

take place most suitably under such a mixing, which causes a drop in pressure of 0.5 W/kg, most suitably even less. The total time of these reactions is shorter than 600 s, preferably approximately 10-120 s.

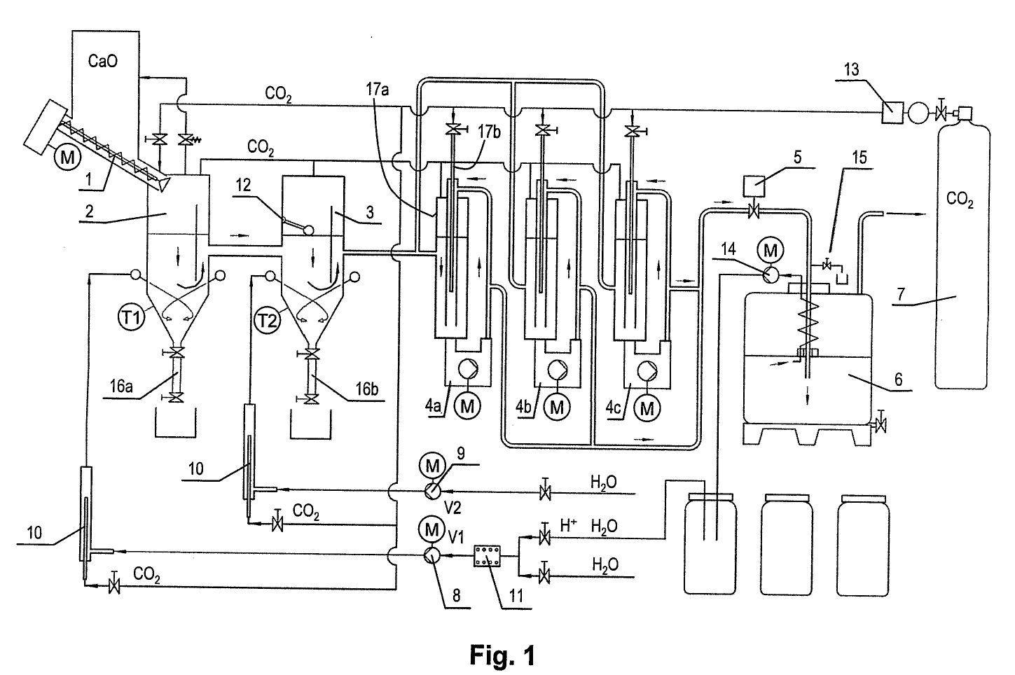

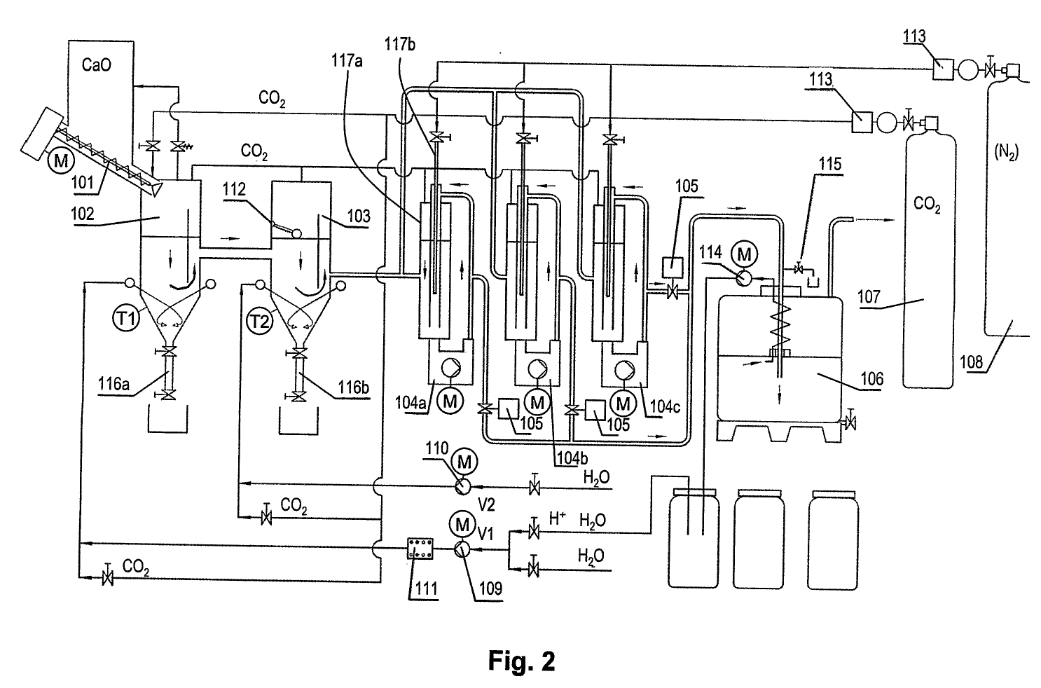

The apparatus which is suitable for the present invention is described with the help of FIGS. 1 and 2.

The present invention is used to produce extremely small particles. The production of nanosized calcium carbonate particles, according to the method described above, will be examined in more detail below.

The size of the CaCO₃ primary crystal is 18.5 Å, which means that the smallest possible size of the CaCO₃ nanoparticles is approximately 2 nm. In the method described above, it is possible to fuse these particles to produce nanoparticles. In the production, it is possible to control the fusing and the crystal growth of the created CaCO₃ primary crystal. In the process, the aim is to reach an equilibrium between the surface energy and the van der Waals' attraction and the kinetic energy.

The equilibrium between the Ca²+ and CO₃²⁻ ions, too, affects the growth of the crystal. Within the desired pH range (pH<7, pH is generally approximately 5.5-6.5), there must be more CO₃²⁻ ions than Ca²+ ions, which is achieved by using a Ca(HCO₃)₂ buffer. It is possible, in turn, to retain the Ca(HCO₃)₂ by preventing the exit from the mixture of the C0₂ which results from the dissolution.

First, a small amount of acidic reaction mixture (pH<7) is prepared. The reaction mixture comprises the following components: H₂O, CO₂, H₂CO₃, Ca(HCO₃) and CaCO₃. The carbon dioxide forms carbonic acid and the carbonic acid, in turn, calcium hydrogen carbonate. After that, the process continues when hydrated lime [Ca(OH)₂ (mixture)] and more carbon dioxide is brought into it. After the carbonation, the suspension comprising calcium carbonate is recovered and taken to the sedimentation stage. The sedimentation is most suitably carried out in a closed container, in which the water comprises dissolved Ca(HCO₃)₂ and CO₂, in which case the “CaCO₃<500 nm” particles form loose agglomerates. These are separated when the percentage of solids is approximately 20-40%, depending on the size of the CaCO₃ nanoparticles. Thus, for instance, 100 nm CaCO₃ particles are separated at a solids percentage of approximately 37% and the 50 nm particles at a solids percentage of 20%.

If the aim is to produce only “CaCO₃<500 nm” particles, the water comprising Ca(HCO₃)₂ is cooled and used completely as carbonation water. On the other hand, if the aim is to produce a suspension which comprises “CaCO₃<500 nm” particles and calcium hydrogen carbonate which is in the liquid phase, there is no need to carry out the Ca(HCO₃)₂ sedimentation.

Quicklime (CaO) always contains some impurities, such as glazed CaO, sand and carbon agglomerates. During the sedimentation process, these collect out at the bottom, from where they are removed. Coarser impurities are removed already at the hydration stage.

The separation of the particles from the acidic water can be carried out either by sedimentation or by centrifugation and by further processing the sediment with an ion separator and drying. The product can be dried by heating and, after that, pulverized.

Sedimentation takes place in the storage space, in which case the particles form loose flocculates. In acidic conditions, the CaCO₃ particles do not exceed the energy threshold, at which point the van der Waals' forces are able to bind the particles into agglomerates which will not be redispersed. The time of sedimentation is typically approximately 1 minute-10 hours, especially 0.5-2 hours.

The dried nanoparticles can be refined with an impact-type refiner, in which case powder of nanoparticle size is generated.

On the basis of what is presented above, according to a preferred embodiment of the present invention, the hydration of calcium hydroxide and the carbonation of hydrated calcium hydroxide are combined so that the calcium oxide is first hydrated in a closed vessel at a temperature of over 100° C. and at a corresponding pressure which prevents the water evaporating. Nanosized calcium hydroxide crystals or particles are generated, the average particle size (particle diameter) of which is approximately 5-100 nm. After that, the calcium hydroxide is carbonated at a predefined solids percentage in a slightly acidic aqueous phase and at overpressure, in order to produce nanosized calcium carbonate particles.

The size of the particles to be produced varies depending on the percentage of solids in the suspension produced. Typically, the solids percentage of particles of approximately 200 nm is approximately 37% and the solids percentage of particles of approximately 100 nm is approximately 31% and the solids percentage of particles of approximately 2 nm is less than 2% (16 g/l).

The calcium carbonate which is produced according to the present invention is suitable as a filler and an additive in various materials, such as polymers, rubber and concrete, and as a compound material for instance in pharmaceutical materials and paints.

It should be noted that the product generated in the carbonation unit, which product comprises an aqueous suspension/solution of calcium carbonate and calcium hydrogen carbonate is usable already as such, i.e. without separation, drying and refining. For example, the suspension can be used as the water used in producing concrete when making cement-based products, in which case the mixture in question is mixed with the hydraulic binder and the basic material, in order to produce a hardener binder product. The calcium hydrogen carbonate in the suspension reacts with the calcium hydroxide which is released during the hardening reaction of the hydraulic binder, in which case more nanoparticles of calcium carbonate are formed in the mixture, which particles, having a large surface area, improve the strength and frost-proofing properties of the hardening product. This usage has been described in more detail in our parallel FI Patent Application 20051183, the name of which is “Aqueous suspension based on a hydraulic binder and a process for the production thereof”.

The speed of the process according to the present invention is formed by the sum of several elements:

1. Rapidly reacting CaO—for instance at a temperature of 60° C., the hydration reaction can take approximately 5 seconds.
2. When the hydration water comprises crystal nuclei, such as calcium hydrogen carbonate

Ca(HCO₃)₂+Ca(OH)₂2CaCO₃+2H₂O

CaCO₃2 nm

3. High temperature >100° C. (approximately 140° C.) generates Ca(OH)₂ crystals, the size of which is <100 nm, especially approximately 10-60 nm.
4. Pressurized CO₂ microbubbles are fed into the slurry comprising nanosized crystals of Ca(OH)₂.
5. The Ca(OH)₂ crystal slurry and the pressurized CO₂ microbubbles are subjected to a strong turbulence.
6. The whole process is carried out under pressure.

According to a preferred embodiment of the present invention, the apparatus comprises, arranged in cascade, a unit for the hydration of the calcium oxide, a unit for the carbonation of the hydrated calcium oxide and optionally a unit for the separation of calcium carbonate.

The hydration unit is equipped with
input nozzles for calcium oxide and water and
an outlet nozzle for aqueous suspension of hydrated calcium oxide, and the carbonation unit, in turn, is equipped with
an input nozzle for aqueous suspension of calcium oxide, which nozzle is connected to the above mentioned outlet nozzle of the hydration unit,
an input nozzle for carbon dioxide, which nozzle is connected to the carbon dioxide source, and
an outlet nozzle for aqueous suspension of calcium carbonate.

The hydration unit is sufficiently well sealed to enable the generation of an overpressure inside it, and in turn perform the hydration at an elevated temperature, that is to say a temperature which is higher than the boiling point of water at normal atmospheric pressure. The raised pressure makes it possible to keep the hydration water in the liquid phase.

The structure of the carbonation unit, too, is sufficiently well sealed to minimize the release of gaseous carbon dioxide resulting from the disintegration of calcium hydrogen carbonate. Also, the use of pressure in the carbonation transfers the carbonic acid formation equilibrium to the right.

On the basis of what is presented above, according to a preferred embodiment of the present invention, the apparatus comprises, arranged in series, a unit for the hydration of calcium oxide, a unit for the carbonation of hydrated calcium oxide and a sedimentation unit, in which case at least the hydration unit and the carbonation unit each comprise a closed space, wherein it is possible to carry out the hydration and the carbonation at overpressure.

When the process in the apparatus is started, the Ca(OH)₂ solution, which is in the reaction section, is processed to a pH value which is below 7, especially approximately 5.5-6.5, after which some of the mixture, the pH of which is below 7, is continuously taken out of the reaction section and, at the same time, a corresponding amount of Ca(OH)₂ mixture is fed into the section, which mixture is carbonated by the Ca(HCO₃)₂ which works as a buffer.

The amount of suspension which is circulated in the carbonation stage, is typically 5-100 fold, typically approximately 10-50 fold larger than the amount of suspension which is taken out as the product.

The surfaces of the liquids in the apparatus tend to remain at a constant level if the volume of the CaCO₃ mixture taken out is such that the pH of the suspension remains at a value below 7. In this case, new Ca(OH)₂ mixture, which is to be processed, flows in to replace the quantity removed.

Adjustment of the process is carried out by controlling the pH value of the processed CaCO₃ product. Adjustment of the pH is easier in acidic mixtures than in alkaline mixtures, because the measuring sensors remain clean.

The unit for separation of calcium carbonate comprises a sedimentation unit, in which it is possible to separate the calcium carbonate.

The present invention can be carried out for instance in apparatuses shown in FIGS. 1 and 2.

According to the first embodiment, the carbonation is carried completely in one carbonation unit and the number of parallel units depends on the volumes of production. In the second embodiment, the carbonation is carried out in reactors which are in series, and such units in series are placed parallel to one another. The number of parallel units depends on the volumes of production. In the reactors which are in series, it is possible to add to the reactors the blending agents in a more controlled manner during the different steps. However, the pH value throughout the process remains acidic even though a number of the Ca(OH)₂ particles have not reacted. In the parallel carbonation reactors, it is possible to simultaneously change different nanoparticles.

Description of the apparatus

In the enclosed flow sheets, the following numbering has been used:
1; 101 CaO doser, which comprises the screw 1a; 101a, to which the calcium oxide container 1b; 101b is connected.
2; 102 Closed mixing container, which is connected to the calcium oxide dosing device 1; 101.
3; 103 Mixing container, in which it is possible to cool the calcium hydroxide slurry coming from the hydration stage.
4a-c; 104a-c Carbonation reactors
5; 105 Control valve
6; 106 Sedimentation container
7; 107 Carbon dioxide storage (for instance a gas bottle)
8; 108 Hydration water pump
9; 109 Dilution water pump
10a,b; 110a,b Carbon dioxide input pipe
11; 111 Resistance heater
12; 112 Meter for measuring surface level
13; 113 Pressure and flow adjuster
14; 114 Discharge pump with a floating suction end 14a; 114a
15; 115 Sampling valve
16a, 116a Stone filter
16b, 116b Stone filter
17a; 117a Bypass flow pipe
17b; 117b Input pipe

In the following, reference is made primarily to the embodiment according to FIG. 2.

First, CaO is fed by means of the screw construction into the pressurized reaction space, the temperature being >100° C. The CaO comes to the feeding screw, 1a, which is most suitably built in such a way that its core and outer part do not move, only the spiral part rotates and feeds the CaO into the pressurized space 2, into which hot water is fed so that the hydration temperature rises to above 100° C. The end of the feeding screw can be equipped with a stop valve, which is opened by the pressure caused by the screw. The container 2 is most suitably equipped with a temperature sensor (T1) and, in order to maintain the temperature, the wall of the container can be equipped with heat insulation.

A reaction takes place, in which energy is released:

CaO+H₂O→Ca(OH)₂ 67 kJ/mole

The pressure is maintained by CO₂ gas (overpressure, for instance 4 bar).

The reaction speed increases at a high temperature. For instance at a temperature of 60° C. 5 s
(20-60° C.) c/c 40° C.
20-140° C. c/c 80° C.

There is a 2-3 fold increase in the reaction speed per each 10° C.
5 s/24=0.3 s
5 s/34=0.06 s

When the reaction speed increases, the size of the generated Ca(OH)₂ crystals decreases to less than 100 nm.

The hydrated lime Ca(OH)₂ flows into the cooling container 3, and from there, onwards to the carbonation units 4a-4c. Each carbonation unit comprises the wing mixer 17a and the CO₂ input pipe 17b.

The Ca(OH)₂ crystals generated are carbonated immediately. The hydration water comprises Ca(HCO₃)₂ and CaCO₃2 nm particles, which particles generate or act as crystal nuclei.

The CO₂ gas is fed into the Ca(OH)₂ slurry in the form of pressurized bubbles. The Ca(OH)₂ crystals, the water and the CO₂ bubbles are mixed, which accelerates the reaction

Ca(OH)₂+CO₂-CaCO₃+H₂O

The above procedure is repeated enough times to lower the pH of the solution to a value of <7 (generally approximately 5.8-6.8 or 5.8-6.5). In this case, the growth of the CaCO₃ crystals in the carbonation unit ceases.

The outlet flow of the final product is adjusted with the choke valve 13.

The CaCO₃ slurry is sedimented out in the container 6 and discharged, using the pump 15, from above into the storage containers.

In one of the containers there is water, the pH of which is 5.5-6.5. This water is returned into the hydration container 2 in such a way that it produces a mixing swirl.

The CO₂ is fed into the carbonation units 4a-4c and the excess CO₂ gas goes through the adjustment pipe system into the hydration container and in turn into the CaO container. The carbon dioxide is brought into the adjustment pipe 17a via the feeding pipe 17b, in which case the flow speed of the slurry is approximately 1-10 m/s, especially approximately 2-4 m/s. The carbon dioxide is fed into the carbon hydroxide slurry as bubbles, the size of which is most suitably approximately 5-20 micrometres. The temperature is approximately 20-60° C. at the beginning of the carbonation.

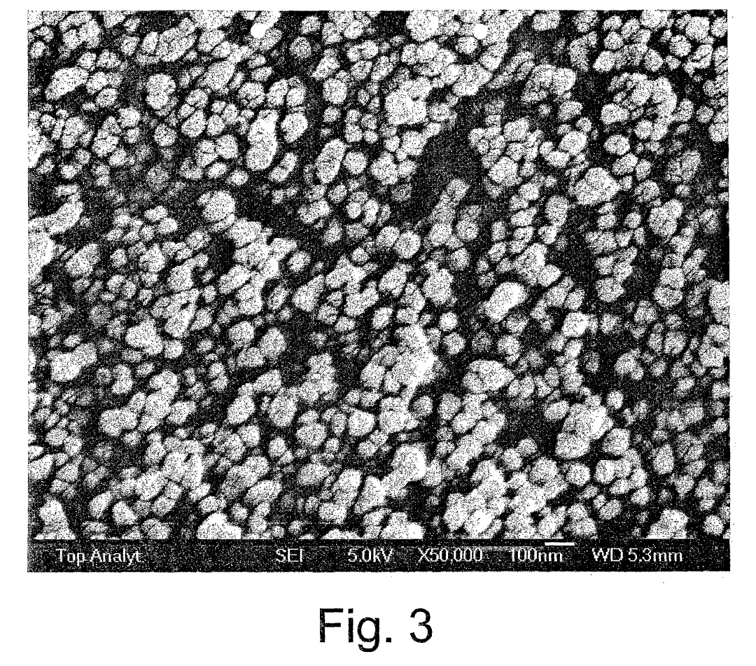

As described above, the carbonation is carried out during mixing. In the cases according to FIGS. 2 and 3, the mixing is carried out with a wing mixer or a wing pump, in which the feed is led in between the wings and removed from the outer edge of the wings.

The pressure required by the reactions is generated by the carbon dioxide. The apparatus is constructed in such a way that it is possible to generate overpressure in the carbonation unit, preferably approximately 1.1-11 bar, especially 1.5-11 bar absolute pressure. The hydration unit, too, is preferably a closed vessel or pressure vessel, in which it is possible to generate overpressure, preferably approximately 1.1-11 bar, especially 1.5-11 bar absolute pressure.

The operation of the apparatus is monitored by watching the equilibrium with a meter that measures surface level by increasing or reducing the cold water feed.

The stopping or starting of the apparatus is carried out by closing or opening the choke valve, which changes the surface level in container 12, which, in turn, stops or starts the other functions.

The feeding of cold and hot water is kept constant by means of the pumps 8 and 9.

The CO₂ gas is introduced into the process from container 7 via the volume and pressure control valves.

An apparatus according to FIG. 3 operates in a similar way to the solution described above, except that the carbonation reactors 104a-104c are not connected in series, as they are in FIG. 1, but instead, they are arranged parallel to each other, in which case it is possible to produce different products in separate reactors. It is possible to operate with different percentages of solids and different pH values.

Generally, the number or reactors can be 1-10 (connected in series or parallel to each other).

### EXAMPLE

Calcium carbonate particles were prepared with an apparatus according to FIG. 1. Calcium oxide was hydrated into three different percentages of solids.

The performance of the test:
1. CaO was fed via the feeding screw 1 into the mixing container 2, where it was brought into contact with the hydration water bearing calcium hydrogen carbonate. The calcium oxide was hydrated according to the reaction CaO+H₂O→Ca(OH)₂. The hydration temperature was approximately 110° C. and, correspondingly, the pressure approximately 1.5 bar (absolute pressure). The percentages of solid calcium oxide in the hydration were:

1. 0.83%

2. 1.64%

3. 3.23%

2. The calcium hydroxide slurry generated was removed after the cooling 3 from the hydration phase and fed into the carbonation reactor 4, in which the calcium hydroxide was carbonated by leading carbon dioxide into the slurry. The carbonation temperature was 42° C. The pH of the circulation water was 5.9 and the quantity per minute was 20 liters.
The input volume of the Ca(OH)₂ slurry, which is fed into the reactor 4, was 1 l/min and the removal volume of the slurry, containing CaCO₃ nanoparticles, was 1 l/ min. The recirculation ratio (ratio between the recirculated slurry/removed slurry) was thus 20:1.
3. The CaCO₃ slurry generated was fed into the sedimentation container 6, where it was allowed to precipitate for 60 minutes, during which the sedimentation almost ceased.

### Analyses:

For the test, samples were taken with a suction tube from the container approximately 20 mm below the surface. The samples were photographed with an electron microscope. The drying which was carried out for this photographing caused a partial coagulation of very small, i.e. under 20 nm particles. As a result, the sizes of the particles, which are included in the flocculated crystal groups, can only be estimated.

At a solids percentage of 0.83%, the hydrated calcium oxide formed crystals, the size of which was approximately 20 nm. These crystals formed coagulated groups, the sizes of which were approximately 200 nm and which did not disintegrate when redispersed. The groups comprised approximately 1000 pcs of 20 nm crystals. Because the aim in this case was to produce small particles, the recirculation ratio should have been decreased to the value of 10:1, in order to avoid coagulation.

It was discovered that, in order to pulverize the slurry in question into small particles, a dispersant, for instance approximately 8 mg/m², must be added into the slurry.

The sizes of the crystal groups generated at a solids percentage of 1.64% were approximately 50-100 nm and it was possible to redisperse them after the pulverizing into particles of equal size.

In the end, 50-200 nm flocculates were generated, which disintegrated into 20-200 nm particles when calcium oxide with a solids percentage of 3.23%, was carbonated.

Consequently, according to the present invention, it is possible to produce nanosized calcium carbonate particles (PCC particles), and it is possible to affect the size of them using the particle size of the hydrated calcium oxide which is brought to the carbonation.

In order to produce 20 nm CaCO₃ particles, the solids percentage must be set at a value which is lower than approximately 1%. By contrast, a solids percentage of approximately 1-5% (especially below 3%) generates 100 nm particles and, correspondingly, a solids percentage of over 5%, typically approximately 6-10%, generates 200 nm particles.

If it is desired to utilize small nanoparticles in pulverized form, it is generally advantageous to add into the slurry some dispersant before the pulverization. Depending on the dispersant, the amount added is approximately 1-50 mg/m², especially approximately 5-20 mg/m².

FIG. 3 shows a SEM picture of the product produced according to the present invention.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method of producing calcium carbonate crystals or particles, according to which method the calcium oxide-bearing initial material is brought in the aqueous phase into contact with carbon oxide, wherein the calcium carbonate crystals or particles are produced in a mixture, the pH of which is below 7, in which case the component which keeps the mixture acidic is calcium hydrogen carbonate, Ca(HCO₃)₂.

2. The method according to claim 1, wherein the pH of the calcium carbonate product mixture is 5.5-6.8, especially 5.8-6.5.

3. The method according to claim 1, wherein the calcium hydrogen carbonate is produced continuously in the mixture by bringing CO₂ gas into the mixture.

4. The method according to claim 1, wherein the quantity of the calcium carbonate crystals and particles and the time used for mixing them in the mixture are used to adjust their sizes.

5. The method according to claim 1, wherein the quantity of the calcium hydroxide mixture which is brought into the process is the same as the slightly acidic CaCO₃ mixture which is removed from the process.

6. The method according to claim 1, wherein the carbonation is carried out using sufficient quantity of Ca(HCO₃)₂ to prevent the pH value of the mixture from exceeding 7, preferably at maximum 6.8.

7. The method according to claim 1, wherein the calcium hydroxide crystals are carbonated in a reactor, in which a mixture having a slightly acidic pH value circulates, the solids percentage of which mixture determines the size of the CaCO₃ particles.

8. The method according to claim 1, wherein the slightly acidic mixture is continuously removed from the reactor while a correspondingly equal quantity of Ca(OH)₂ mixture is continuously fed into the reactor.

9. The method according to claim 8, wherein the pH value of the CaCO₃ mixture to be removed is measured continuously and the quantity of the CaCO₃ mixture to be removed is set so that the pH value of the mixture remains slightly acidic or essentially unchanged.

10. The method according to claim 1, wherein overpressure, preferably 1.5-11 bar absolute pressure, is used in the process.

11. The method according to claim 1, wherein overpressure, preferably 1.5-11 bar absolute pressure, is used in the hydration of the calcium oxide.

12. The method according to claim 11, wherein the hydration of the calcium hydroxide is carried out continuously, in which case the temperature of the hydration process is kept constant by adjusting the temperature of the hydration water.

13. The method according to claim 11, wherein the solids percentage of the calcium hydroxide suspension, which percentage is generated in the hydration, is adjusted by feeding cooling water into it, before the suspension is brought into contact with the carbon dioxide at the carbonation stage.

14. The method according to claim 11, wherein the pressure in the hydration process is generated with CO₂ gas.

15. The method according claim 11, wherein the hydration water comprises 1-16 g/l of calcium hydrogen carbonate.

16. An apparatus for producing calcium carbonate which comprises:
a source of carbon dioxide; and
a carbonation unit for calcium hydroxide, which is equipped with an input nozzle for aqueous suspension of calcium oxide, an input nozzle for carbon dioxide which is connected to the carbon dioxide source, and an outlet nozzle for the aqueous suspension of the calcium carbonate which is generated in the carbonation of calcium oxide,
wherein
the carbonation unit is equipped with a recirculation pipe which is connected to the outlet nozzle for the calcium carbonate, through which pipe at least part of the product from the reactor can be recirculated.

17. The apparatus according to claim 16, wherein the carbonation unit comprises a closed reactor vessel, in which the carbonation reaction can be carried out at overpressure.

18. The apparatus according to claim 16, wherein the carbonation unit comprises a wing mixer or a wing pump.

19. The apparatus according to claim 16, wherein it is possible to arrange an internal circulation in the carbonation unit, and that the quantity of the product which is recirculated through it is 5-20 fold the hydrated calcium oxide which is fed into the carbonation unit.

20. The apparatus according to claim 16, wherein the number of carbonation units is 1-10 and they are arranged in series or parallel to each other.

21. The apparatus according to claim 16, wherein the apparatus comprises, arranged in series, a hydration unit for calcium oxide, a carbonation unit for hydrated calcium and a sedimentation unit, in which case at least the hydration unit and the carbonation unit comprise a closed space, in which it is possible to carry out the hydration and the carbonation at overpressure.

22. The apparatus according to claim 16, wherein it is possible to generate overpressure in the carbonation unit, preferably approximately 1.5-11 bar absolute pressure.

23. The apparatus according to claim 21, wherein it is possible to generate overpressure in the hydration unit, preferably approximately 1.5-11 bar absolute pressure.
